(19) United States
(12) Patent Application Publication
(10) Pub. No.: US 2015/0309597 A1
(43) Pub. Date: Oct. 29, 2015

(54) ELECTRONIC APPARATUS, CORRECTION METHOD, AND STORAGE MEDIUM

(71) Applicant: Kabushiki Kaisha Toshiba, Tokyo (JP)

(72) Inventor: Tetsuya Fujii, Fussa-shi (JP)

(73) Assignee: Kabushiki Kaisha Toshiba, Tokyo (JP)

(21) Appl. No.: 14/265,035

(22) Filed: Apr. 29, 2014

(51) Int. Cl. G06F 3/0354; G06F 3/041

(52) U.S. Cl. CPC G06F 3/03545; G06F 3/0412

(57) ABSTRACT

According to one embodiment, an electronic apparatus includes a display, a storage, a generator and a processor. The display detects a contact position with a first object on the display. The storage stores first data relating to a difference caused by at least a manufacture of a hardware of the electronic apparatus. The generator generates second data relating to a difference in a contact state of a second object with the display. The processor corrects a contact position detected by the display, using the first data and the second data.

### CROSS REFERENCE TO RELATED APPLICATIONS

This application is a Continuation Application of PCT Application No. PCT/JP2013/063071, filed May 9, 2013, the entire contents of which are incorporated herein by reference.

### FIELD

Embodiments described herein relate generally to pen input on a display.

### BACKGROUND

An electronic device including an input device (digitizer) by an electromagnetic guidance type of electronic pen sometimes causes a positional gap (error) between the point actually specified by a user with the pen and the point recognized by the device. This positional gap is caused by hardware mounting, for example, misalignment of incorporation of a sensor and characteristics of the electromagnetic guidance type of electronic pen. In this situation, there is a need for a method for eliminating the gap between the point specified by a user and the point recognized by a terminal.

Conventionally, a positional correction process (calibration process) is often applied to correct a positional gap (error) between the pen point and the coordinate recognized by an apparatus. There are several causes for positional gaps, and some causes are due to hardware such as the error of incorporation of a sensor, and the other causes are due to difference in the method used by a user such as the way of inclining an electronic pen and the disparity by thickness of a glass surface of a display.

In the conventional calibration process, a certain correction process is applied without distinguishing the above causes, therefore, if a pen input state is changed; for example, if an electronic apparatus is rotated and the orientation of an input device (digitizer) is changed, or the inclination of a pen is changed, a positional gap cannot be appropriately corrected. Thus, even if a calibration process is conducted, the point specified by a user does not necessarily conform to the point recognized by the apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective illustration showing an appearance of a tablet computer according to an embodiment.

FIG. 2 is an exemplary illustration showing a system structure of the tablet computer according to the embodiment.

FIG. 3 is an exemplary block diagram showing a functional structure realized by a calibration utility program according to the embodiment.

FIG. 4 is an exemplary view showing an example of second correction data generated by a second correction data generation module according to the embodiment.

FIG. 5 is an exemplary view showing an example of the second correction data generated by the second correction data generation module according to the embodiment.

FIG. 6 is an exemplary conceptual diagram for explaining a positional gap (error) according to the embodiment.

FIG. 7 is an exemplary view showing a positional relationship between an LCD and a sensor sheet according to the embodiment.

FIG. 8 is an exemplary view showing the positional relationship between the LCD and the sensor sheet according to the embodiment.

FIG. 9 is an exemplary view showing a relationship between a positional gap caused by hardware and a positional gap caused by the way used by a user according to the embodiment.

FIG. 10 is an exemplary view showing an example in which the tablet computer of the embodiment is rotated 90 degrees in the left direction to change the orientation of a touchscreen display.

FIG. 11 is an exemplary diagram for explaining a correction process by the calibration utility program according to the embodiment.

FIG. 12 is an exemplary flowchart of a first correction data generation process generating first correction data according to the embodiment.

FIG. 13 is an exemplary view showing an example of a screen for calibration in the first correction data generation process according to the embodiment.

FIG. 14 is an exemplary flowchart of a second correction data generation process generating second correction data according to the embodiment.

FIG. 15 is an exemplary view showing an example of a handwriting input operation according to the embodiment.

FIG. 16 is an exemplary view showing an example of a screen for calibration according to the embodiment.

FIG. 17 is an exemplary conceptual diagram for explaining the inclination of a pen according to the embodiment.

FIG. 18 is an exemplary view showing an example of a screen for calibration according to the embodiment.

FIG. 19 is an exemplary view showing an example of a screen for calibration according to the embodiment.

FIG. 20 is an exemplary view showing an example of a screen for calibration according to the embodiment.

FIG. 21 is an exemplary view showing a state in which a hand holding a pen makes contact with a screen at the time of an input operation according to the embodiment.

FIG. 22 is an exemplary diagram for explaining a principle correcting data for generating correction data according to the embodiment.

FIG. 23 is an exemplary diagram for explaining a principle extracting a gap component according to the embodiment.

FIG. 24 is an exemplary flowchart showing a correction process using the first correction data and the second correction data according to the embodiment.

FIG. 25 is an exemplary view showing an example of the state of use of the tablet computer according to the embodiment.

FIG. 26 is an exemplary view showing an example of the state of use of the tablet computer according to the embodiment.

### DETAILED DESCRIPTION

Various embodiments will be described hereinafter with reference to the accompanying drawings.

In general, according to one embodiment, an electronic apparatus includes a display, a storage, a generator and a processor. The display is configured to detect a contact position with a first object on the display. The storage is configured to store first data relating to a difference, caused by at least a manufacture of a hardware of the electronic apparatus, between a first position at which the first object makes contact with the display and a second position drawn by the display in accordance with first positional information obtained in accordance with the contact of the first object with the display at the first position. The generator is configured to generate second data relating to a difference in a contact state of a second object with the display. The second data is used for determining a fourth position drawn by the display in accordance with second positional information obtained in accordance with contact of the second objet with the display at a third position. The processor is configured to correct a contact position detected by the display, using the first data and the second data.

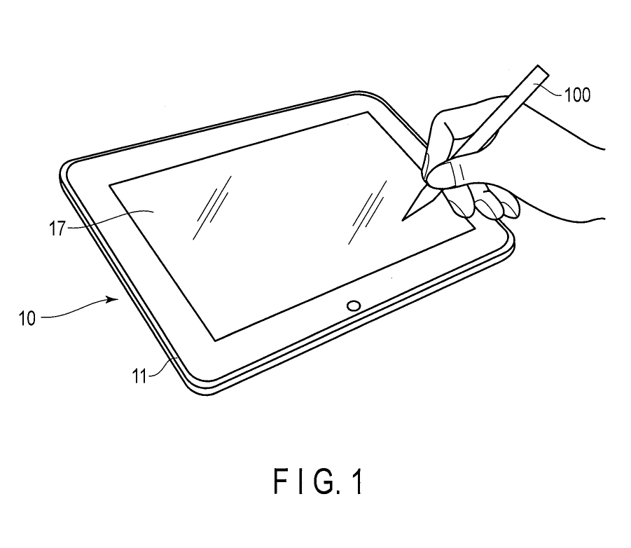

FIG. 1 is an exemplary perspective illustration showing an appearance of a tablet computer 10 according to the embodiment. The tablet computer 10 is a portable electronic apparatus which is also called a tablet or a slate computer, and includes a main body 11 and a touchscreen display 17. The touchscreen display 17 is attached to the upper surface of the main body 11.

The main body 11 has a housing having a thin box shape. A flat panel display, and a sensor configured to detect a contact position of a pen or a finger on a screen of the flat panel display are incorporated into the touchscreen display 17. The flat panel display may be, for example, a liquid crystal display device (LCD). As the sensor, for example, a capacitance type of touchpanel, and an electromagnetic induction type of digitizer can be employed. Following examples assume a case where both of the two types of sensors, a digitizer and a touchpanel, are incorporated into the touchscreen display 17.

The sensor corresponding to the digitizer may be any sensor as long as it is configured to detect the contact between a pen and the touchscreen display 17.

The sensor corresponding to the touchpanel may be any sensor as long as it is configured to detect the contact between an object (for example, a hand or a finger of a human) and the touchscreen display 17. For example, in the case where multi-touch is detectable by the capacitance type, it is possible to detect contact at a plurality of adjacent points.

Each of the digitizer and the touchpanel is provided so as to cover the screen of the flat panel display. The touchscreen display 17 is configured to detect a touch operation relative to the screen by the use of a finger as well as the use of a pen 100. The pen 100 may be, for example, an electromagnetic guidance pen. A user is able to conduct input operations in handwriting on the touchscreen display 17, using an external object (the pen 100 or a finger). During the input operations in handwriting, the trace of movement of the external object (the pen 100 or a finger) on the screen; in other words, the trace (writing) of strokes written by input operations in handwriting is drawn in real time, and thus, the trace of each stroke is displayed on the screen. The trace of movement of the external object for the duration of the contact of the external object with the screen is equivalent to one stroke. The assembly of many strokes that are traces (writing) corresponding to handwritten letters or figures, etc., constitutes a handwritten document.

In the embodiment, the handwritten document is not saved as image data, and is saved in a storage medium as time-series information showing a sequence of coordinates of trace of each stroke and the order relationships among the strokes. The time-series information generally refers to the assembly of time-series stroke data corresponding to a plurality of strokes respectively. Each item of stroke data corresponds to one stroke, and includes coordinate data series (time-series coordinates) corresponding to points on the trace of the stroke respectively. The alignment sequence of these stroke data is equivalent to the stroke order in which the strokes are handwritten.

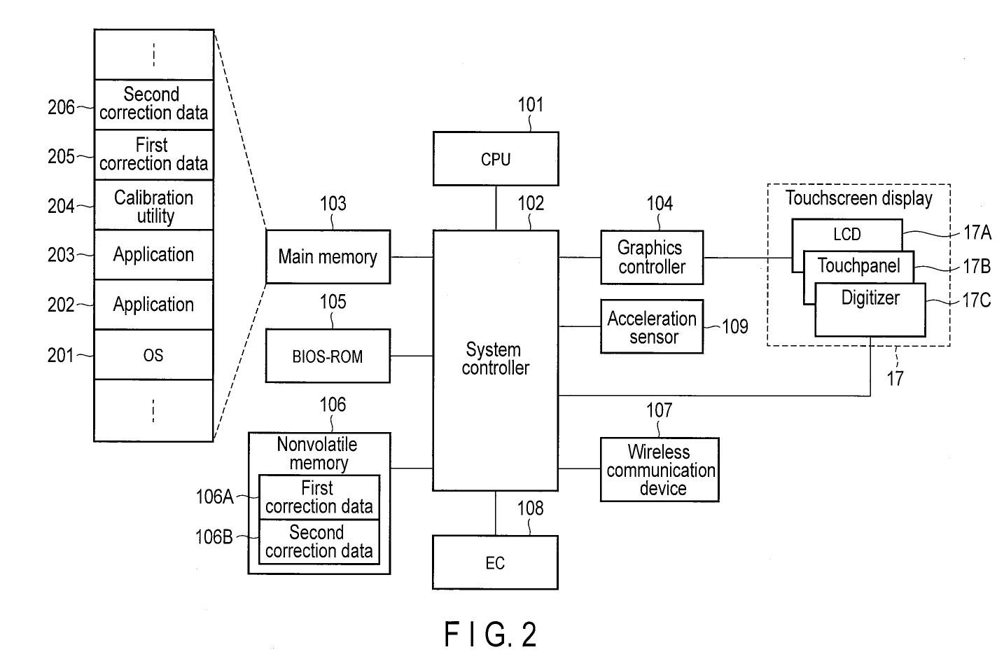

FIG. 2 is an exemplary illustration showing a system structure of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108 and an acceleration sensor 109, etc.

The CPU 101 is a processor configured to control the operation of each module within the tablet computer 10. The CPU 101 executes various types of software loaded from the nonvolatile memory 106 which is a storage device into the main memory 103. The software includes an operating system (OS) 201 and various types of application programs.

The OS 201 is configured to identify the user using the tablet computer 10 based on, for example, a password input by the user at the time of start-up.

The application programs include a plurality of application programs 202 and 203 configured to process stroke data input by an external object such as the pen 100, and also includes a calibration utility program 204 configured to correct errors of coordinate data input by the input operation of the pen 100.

Application program 202 is configured to, for example, prepare, display and edit a handwritten document by inputting strokes mainly indicating characters, and application program 203 is configured to, for example, prepare and display pictures, etc., by inputting strokes indicating line drawing and color filling. Application programs 202 and 203 include a function of switching the line type to be drawn or the color to be applied, etc., depending on stroke data.

When application program 203 is used, the user sometimes uses the pen 100, holding it in a different way from a case where characters are input in handwriting. In other words, when application program 203 is executed, the inclination of the pen 100 relative to the touchscreen display 17 is different from a case where characters are handwritten by the use of application program 202.

The calibration utility program 204 executes a process for correcting a positional gap (error) between the contact position intended by the user by the use of the pen 100 relative to the touchscreen display 17 and the line (stroke) drawn on the touchscreen display 17 in accordance with the contact position. The calibration utility program 204 includes a function of separately correcting the detection error of the contact position due to hardware mounting, and the detection error of the contact position due to the difference in the contact state of the pen 100 relative to the touchscreen display 17 in two stages. The calibration utility program 204 loads first correction data 106A and second correction data 106B which are recorded in the nonvolatile memory 106 into the main memory 103. The calibration utility program 204 corrects the coordinate data detected by the touchscreen display 17 (digitizer 17C) based on first correction data 205 and second correction data 206 which are loaded into the main memory 103, and outputs the corrected data to the OS 201 and application programs 202 and 203.

The CPU 101 also executes a basic input/output system (BIOS) stored in the BIOS-ROM 105. The BIOS is a program for controlling hardware.

The system controller 102 is a device configured to connect a local bus of the CPU 101 to various components. A memory controller configured to control access of the main memory 103 is incorporated in the system controller 102. The system controller 102 is also includes a function of executing communication with a graphics controller 104 via a PCI EXPRESS serial bus, etc.

The graphics controller 104 is a display controller configured to control an LCD 17A used as a display monitor of the tablet computer 10. A display signal generated by the graphics controller 104 is sent to the LCD 17A. The LCD 17A displays a screen image based on the display signal. On the LCD 17A, a touchpanel 17B and a digitizer 17C are allocated. The touchpanel 17B is a capacitance type of pointing device for conducting input on the screen of the LCD 17A. The touchpanel 17B detects a contact position of a finger on the screen and the movement of the contact position, etc. The touchpanel 17B outputs a coordinate indicating the contact position on the screen. The digitizer 17C is an electromagnetic guidance type of pointing device for conducting input on the screen of the LCD 17A.

The digitizer 17C detects a contact position (coordinate) of the pen 100 on the screen and the movement of the position of the pen 100, etc. The digitizer 17C outputs coordinate data indicating the contact position of the pen 100 on the screen.

The wireless communication device 107 is configured to execute wireless communication such as a wireless LAN and 3G mobile communication. The EC 108 is a single-chip microcomputer including an embedded controller for power management. The EC 108 includes a function of turning the tablet computer 10 on or off in accordance with the operation of a power button by a user.

The acceleration sensor 109 is configured to detect the movement and the direction of gravitational force (static acceleration) of the tablet computer 10. The OS 201 detects the placement state of the tablet computer 10 based on the detection result by the acceleration sensor 109, and determines the orientation of the touchscreen display 17. The orientation of the screen displayed on the touchscreen display 17 can be changed by determining the orientation of the touchscreen display 17. Moreover, it is possible to determine from which direction a user conducts an input operation by the use of the pen 100 relative to the touchscreen display 17.

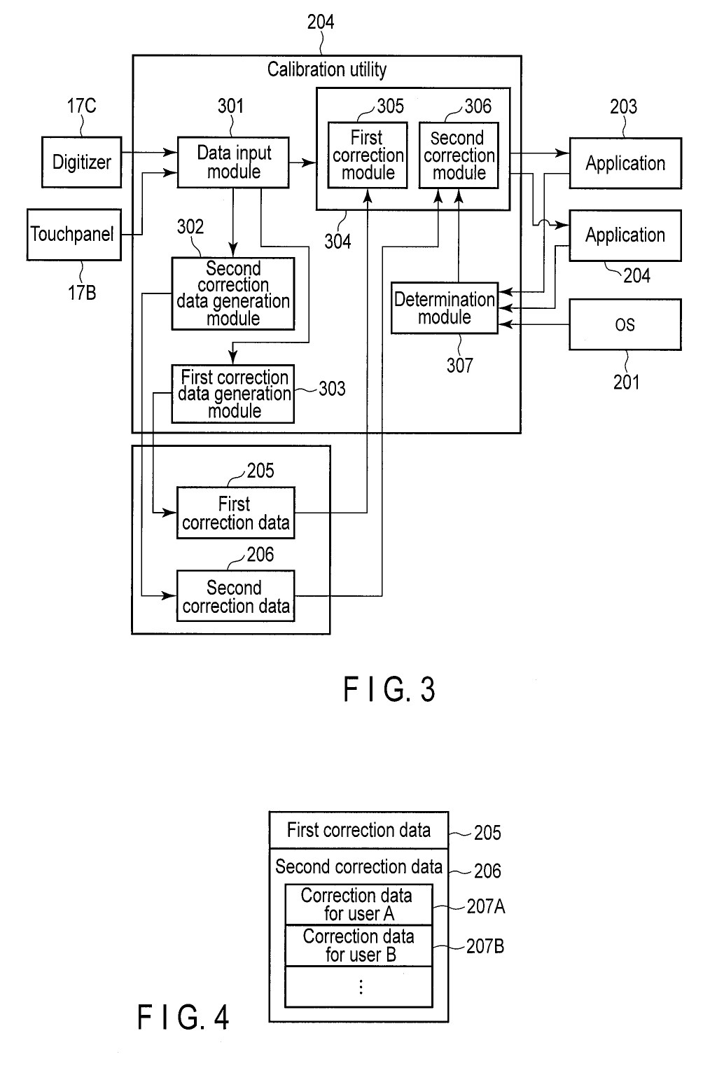

Next, this specification explains a functional structure of the calibration utility program 204. FIG. 3 is an exemplary block diagram showing the functional structure realized by the calibration utility program 204.

As indicated in FIG. 3, the calibration utility program 204 includes a data input module 301, a first correction data generation module 303, a second correction data generation module 302, a correction module 304 (a first correction module 305 and a second correction module 306) and a determination module 307 by executed by the CPU 101.

The data input module 301 is a module configured to input a detection signal output from the digitizer 17C. The detection signal output from the digitizer 17C includes coordinate data indicating a contact position of the pen 100 with the touchscreen display 17. The data input module 301 is also configured to input a detection signal from the touchpanel 17B.

The first correction data generation module 303 generates first correction data for correcting a detection error of a contact position due to hardware mounting based on the coordinate data input from the data input module 301, and records the first correction data in the nonvolatile memory 106.

The second correction data generation module 302 generates second correction data for correcting a detection error of a contact position due to the difference in the contact state of the pen 100 relative to the touchscreen display 17, and records the second correction data in the nonvolatile memory 106. The second correction data may include a plurality of items of correction data corresponding to the difference in the operation state of the tablet computer 10.

The correction module 304 corrects the coordinate data indicating the contact position of the pen 100, which is detected by the touchscreen display 17 (digitizer 17C), and includes the first correction module 305 and the second correction module 306. The first correction module 305 corrects coordinate data based on the first correction data 205 generated by the first correction data generation module 303. The second correction module 306 corrects coordinate data corrected by the first correction module 305 based on second correction data 206 generated by the second correction data generation module 302. In short, the correction module 304 corrects coordinate data detected by the digitizer 17C in two stages.

The determination module 307 determines how the tablet computer 10 is used by a user, and notifies the second correction module 306 of the way of using the tablet computer 10. Specifically, the determination module 307 determines the operation state generating the difference in the contact state of the pen 100 relative to the touchscreen display 17 based on the notification from the OS 201 and application programs 202 and 203, and notifies the second correction module 306 of the operation state. The operation state determined by the determination module 307 is, for example, the orientation of the touchscreen display 17, the user of the tablet computer 10, the active application processing coordinate data input from the digitizer 17C, the function executed by an application (such as the type of the line drawn in accordance with stroke data) and the hand (right hand or left hand) with which the pen 100 is held by the user.

The second correction module 306 is configured to select one of a plurality of items of correction data in accordance with the operation state informed from the determination module 307, and use the selected data for the correction process.

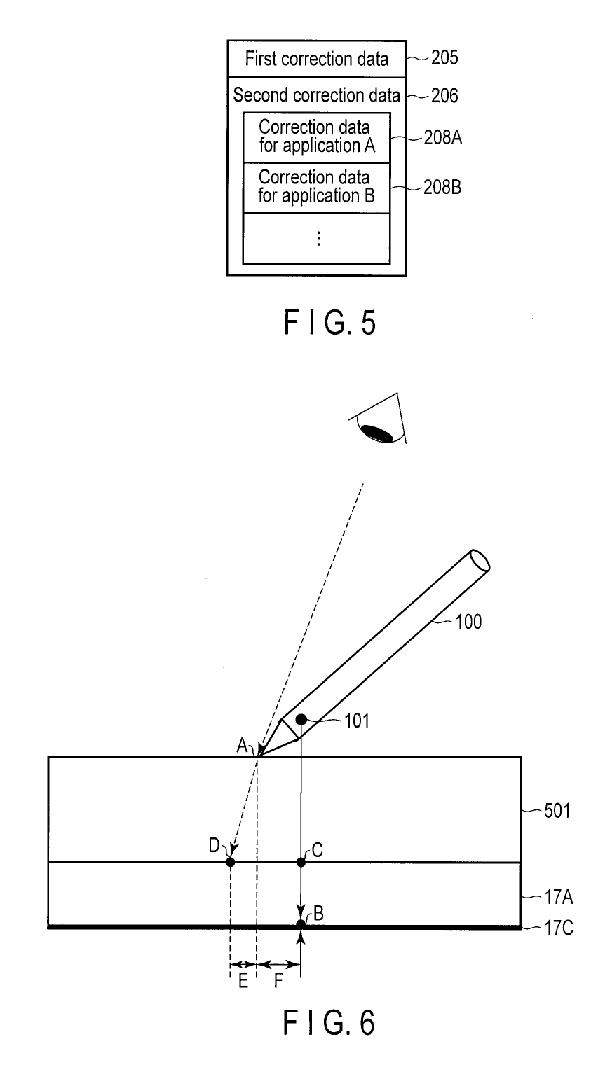

FIG. 4 and FIG. 5 are exemplary view showing examples of the second correction data 206 generated by the second correction data generation module 302.

FIG. 4 is an exemplary view showing an example of the second correction data 206 including correction data corresponding to each of a plurality of users (user A, user B, . . . ) of the tablet computer 10. As indicated in FIG. 4, the second correction data 206 includes a plurality of items of correction data corresponding to the plurality of users (user A, user B, . . . ), such as correction data 207A for user A, correction data 207B for user B, . . . .

In general, different users hold the pen 100 in different ways. Therefore, when users conduct handwriting input on the touchscreen display 17, using the pen 100, the inclination angle of the pen 100 relative to the touchscreen display 17 varies from one user to another; thus, the detection error differs depending on the user. These detection errors different from each other depending on the user can be appropriately corrected by using correction data corresponding to each user.

FIG. 5 is an exemplary view showing an example of the second correction data 206 including correction data corresponding to each of a plurality of applications (application A, application B, . . . ) executed in the tablet computer 10. As illustrated in FIG. 5, the second correction data 206 includes a plurality of items of correction data corresponding to the plurality of applications (application A, application B, . . . ), such as correction data 208A for application A, correction data 208B for application B, . . . .

Generally, a user holds the pen 100 in a different way when inputting characters in handwriting from when drawing pictures, etc., in handwriting. Therefore, the inclination angle of the pen 100 relative to the touchscreen display 17 differs between the case of executing an application for inputting characters in handwriting and the case of executing an application for preparing pictures, etc., in handwriting; for this reason, detection errors vary depending on the application. These detection errors which differ depending on the application can be appropriately corrected by using correction data corresponding to each application.

FIG. 4 and FIG. 5 show the example in which correction data for users or correction data for applications are included in the second correction data 206; however, the second correction data 206 may include a plurality of items of correction data corresponding to other operation states generating differences in the contact state of the pen 100. For example, the second correction data 206 may include a plurality of items of correction data corresponding to a plurality of functions executed in applications (the types of lines drawn in accordance with stroke data), and correction data for a right hand and correction data for a left hand correspond to the case where a user operates the pen 100 using his right hand and left hand.

The calibration utility program 204 according to the embodiment corrects a detection error of a contact position due to hardware mounting by a correction process in a first stage by the use of the first correction data 205. Thus, detection errors generated in a fixed manner are corrected by the first correction data, therefore, it is possible to appropriately correct both of the detection error caused by hardware mounting and the detection error due to the way used by a user by dynamically associating only a correction process in a second stage with the operation state.

Next, this specification explains the cause of the positional gap (error) between the contact position intended by the user using the pen 100 relative to the touchscreen display 17 and the line (stroke) drawn on the touchscreen display 17 in accordance with the contact position.

FIG. 6 is an exemplary conceptual diagram for explaining a positional gap (error). As shown in FIG. 6, when handwriting input is conducted with the pen 100, the pen 100 is inclined, and its pen point makes contact with the input surface of the touchscreen display 17. If a user conducts an input operation at a point A on the input screen, electromagnetic waves are emitted from the magnet coil 101, and these electromagnetic waves are most strongly received at a point B on the sensor surface of the digitizer 17C. Therefore, point B on the digitizer 17C is detected as a contact position of the pen 100, and the line showing the touched position on the LCD 17A is displayed at a point C vertically above point B.

In the electromagnetic induction type, the position at which the electromagnetic coil 101 housed in the pen 100 is the closest to the sensor sheet surface of the digitizer 17C is detected as the contact position of the pen point, therefore, there is a gap between the actual pen point and the position detected as coordinate, thus the more the pen 100 is inclined, the larger a positional gap F by the inclination of the pen 100 becomes.

Further, since a protection material (glass, etc.) 501 for protecting the LCD 17A is provided on the surface, a disparity E is generated between the position of the line actually shown on the LCD 17A and the position of the pen point assumed by a user in a direction of eyes.

Because of the disparity E due to the thickness of the protection material 501 and the positional gap F due to the inclination of the pen 100, as shown in FIG. 6, a positional gap (detection error) is generated between a position D of the line expected by a user to be drawn and the position C of the line actually displayed.

Next, this specification explains the detection error caused by hardware mounting between the contact position of the pen 100 and the coordinate detected by the digitizer 17C.

The tablet computer 10 including the digitizer 17C using the electromagnetic induction type of pen 100 includes a sensor sheet 17C1 of the digitizer 17C underneath the LCD 17A. The digitizer 17C detects electromagnetic waves generated from the pen 100 by the sensor sheet 17C1.

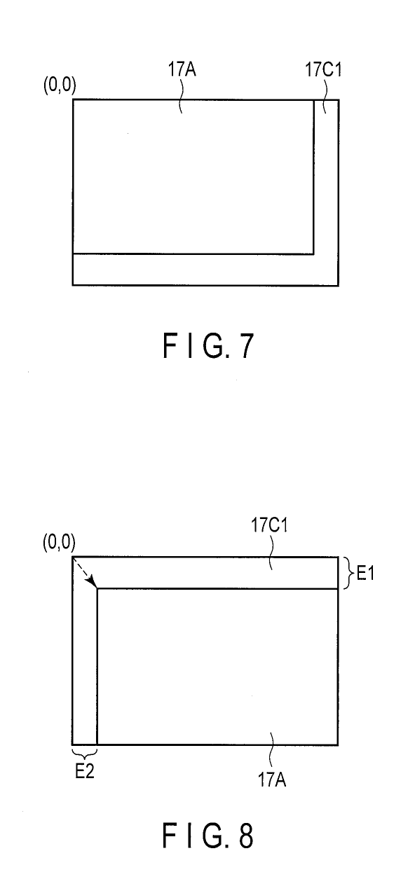

The LCD 17A and the sensor sheet 17C1 are composed in such a way that the origin set on the upper left of the LCD 17A and the sensor sheet 17C1 can conform to each other, as shown in, for example, FIG. 7. However, an incorporation error is sometimes caused at the time of assembly; for example, as shown in FIG. 8, positional gaps E1 and E2 could occur in the LCD 17A and the sensor sheet 17C1. In the example shown in FIG. 8, the origin (0, 0) of the LCD 17A is deviated to the lower right.

Therefore, when a stroke is handwritten with the pen 100, a positional gap (detection error) is generated between the coordinate data sequence showing the trace of the pen point detected by the sensor sheet 17C1 and the line displayed on the LCD 17A in accordance with the coordinate data sequence.

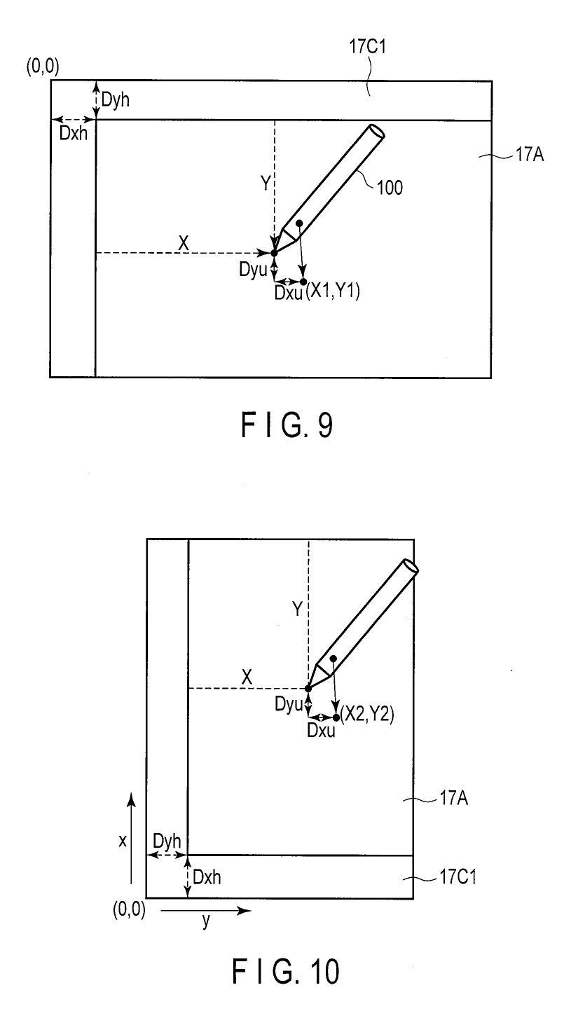

FIG. 9 is an exemplary view showing a relationship between the positional gap caused by hardware and the positional gap due to the way used by a user.

The example of FIG. 9 shows that the pen point of the pen 100 is intentionally brought into contact with a point (X, Y) on the LCD 17A by a user. If a positional gap caused by hardware is set as (Dxh, Dyh), and a positional gap depending on the way used by the user is set as (Dxu, Dyu), the relationship between point (X, Y) intended by the user and a point (X1, Y1) recognized by the tablet computer 10 as instructed by the user is shown by the following equations (1) and (2):

X=X1−Dxh−Dxu (1)

Y=Y1−Dyh−Dyu (2)

FIG. 10 indicates an example in which the tablet computer 10 is rotated at 90 degrees in the left direction to change the orientation of the touchscreen display 17. In the operation state shown in FIG. 10, the direction of the positional gap depending on the way used by the user differs by 90 degrees relative to the coordinate system of the digitizer 17C (sensor sheet 17C1); therefore, the relationship between point (X, Y) actually specified by the user on the LCD 17A and point (X2, Y2) recognized by the tablet computer 10 is shown by the following equations (3) and (4):

X=X2−Dxh+Dyu (3)

Y=Y2−Dyh−Dxu (4)

Thus, the calculation method of the coordinate data correction differs depending on the orientation of the tablet computer 10 (touchscreen display 17).

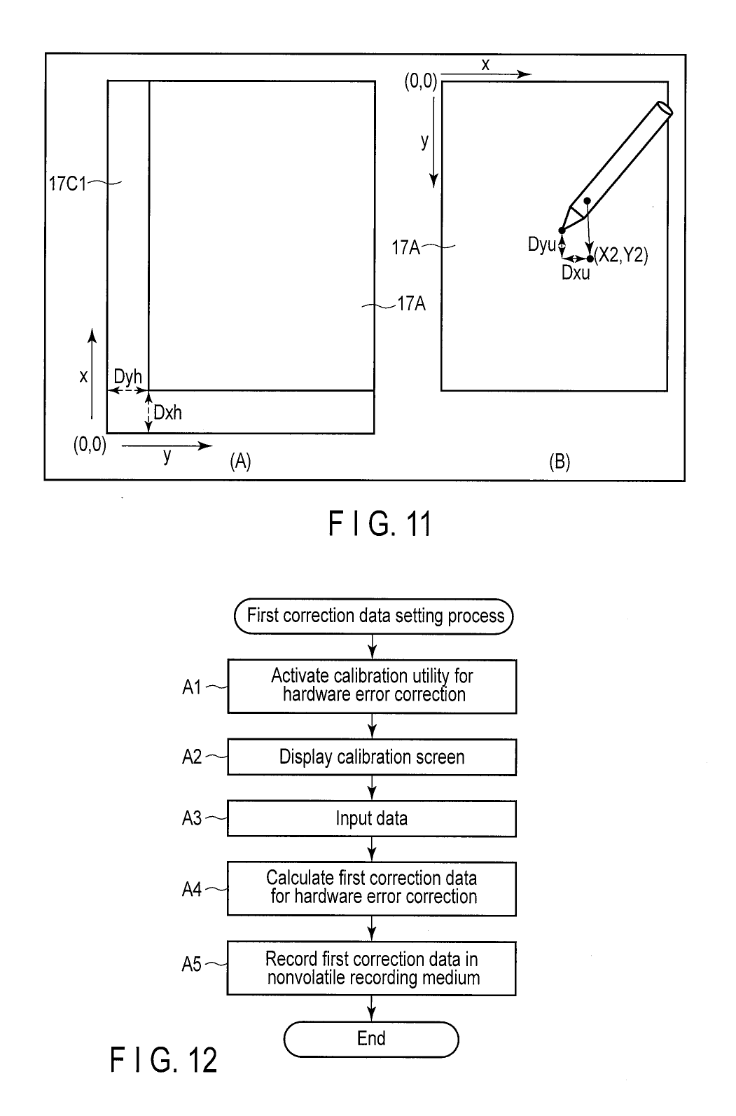

However, the calibration utility program 204 of the embodiment separates the correction of the positional gap caused by hardware in FIG. 11(A) from the correction of the positional gap depending on the way used by a user in FIG. 11(B), and firstly corrects the positional gap caused by hardware, and then corrects the positional gap depending on the way used by the user, thus, the correction is conducted in two stages. In this manner, even if the tablet computer 10 is rotated to change the orientation of the touchscreen display 17; in other words, the orientation of the input operation by the pen 100 relative to the touchscreen display 17, it is possible to conduct an appropriate correction process in accordance with the orientation of the touchscreen display 17 by dynamically changing the calculation method of the correction process.

Next, this specification explains operations by the calibration utility program 204 according to the embodiment.

First, the first correction data generation process which generates the first correction data is explained by reference to the flowchart shown in FIG. 12. The first correction data generation process is a process for generating the first correction data which corrects the detection error generated due to hardware mounting.

The first correction data is correction data unique to the tablet computer 10. Therefore, the first correction data generation process is implemented by, for example, an operation by an administrator in the production line of the tablet computer 10.

The tablet computer 10 activates a calibration utility for hardware error correction by the calibration utility program 204 in response to an operation of an administrator (block A1). The first correction data generation module 303 displays a screen for calibration on the touchscreen display 17 (block A2).

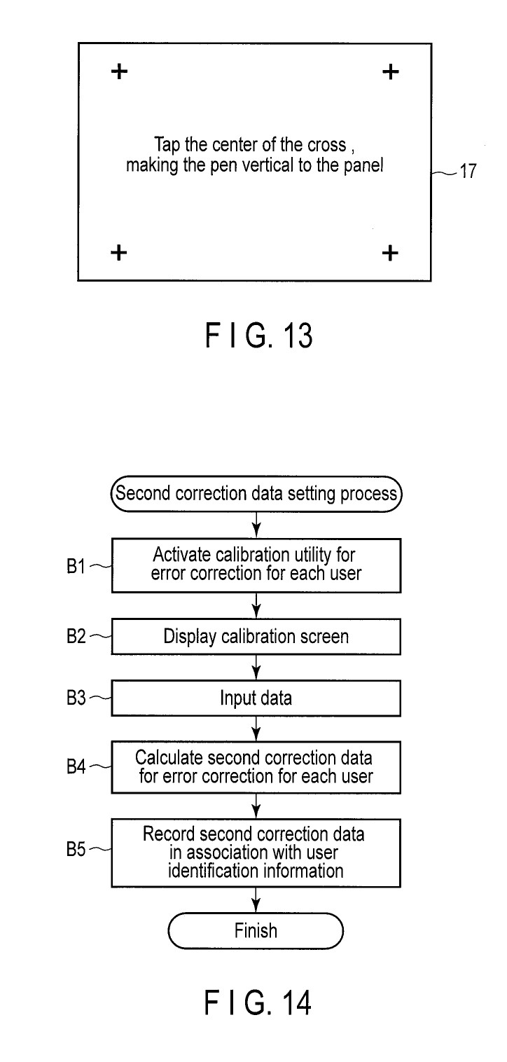

FIG. 13 is an exemplary view showing an example of a screen for calibration in the first correction data generation process.

As shown in FIG. 13, in the screen for calibration, a mark “+” is displayed at four corners of the display screen, and a message “Tap the center of the cross, making the pen vertical to the panel” is displayed.

In the first correction data generation process, in order to eliminate influence of the positional gap due to inclination of the pen 100, etc., an input operation is executed with the pen 100 standing vertically relative to the touchscreen display 17 (LCD17A).

The administrator conducts an input operation relative to the touchscreen display 17, holding the pen 100 vertically and setting the pen point on the mark “+”.

The data input module 301 inputs coordinate data detected in accordance with an input operation by the pen 100 from the digitizer 17C (block A3).

The first correction data generation module 303 calculates difference between the position of the mark “+” displayed on the LCD 17A and the position shown by the input coordinate data in order to obtain the first correction data for hardware error correction (block A4). Thus, the gap (Dxh, Dyh) shown in FIG. 9 is calculated.

The first correction data generation module 303 records the first correction data in the nonvolatile memory 106 (block A5). The tablet computer 10 is shipped out with the first correction data recorded in the nonvolatile memory 106.

Therefore, the user is able to use the tablet computer 10 in which the first correction data unique to the table computer 10 is recorded in advance.

In the above explanation, although the first correction data generation process is performed by an administrator in the manufacturing line, it may be executed by a user. For example, when handwriting input is conducted and the generation of a positional gap is recognized, a user activates the calibration utility program 204 and executes the aforementioned first correction data generation process. Thus, similarly, it is possible to generate the first correction data and record it in the nonvolatile memory 106.

When there is no error in assembling the LCD 17A and the sensor sheet 17C1, the first correction data generation process may be unneeded. Further, if a user executes the first correction data generation process, the operation processes can be reduced in the manufacturing line, and thus, the cost can be decreased.

Next, this specification explains the second correction data generation process which generates the second correction data with reference to the flowchart shown in FIG. 14. The second correction data generation process is a process for generating the second correction data which corrects detection errors caused by the way used by a user.

The tablet computer 10 activates calibration utility for error correction for each user by the calibration utility program 204 (block B1) in accordance with the operation by the user. The second correction data generation module 302 displays a screen for calibration on the LCD 17A (block B2). The specific examples of the screen for calibration are described later.

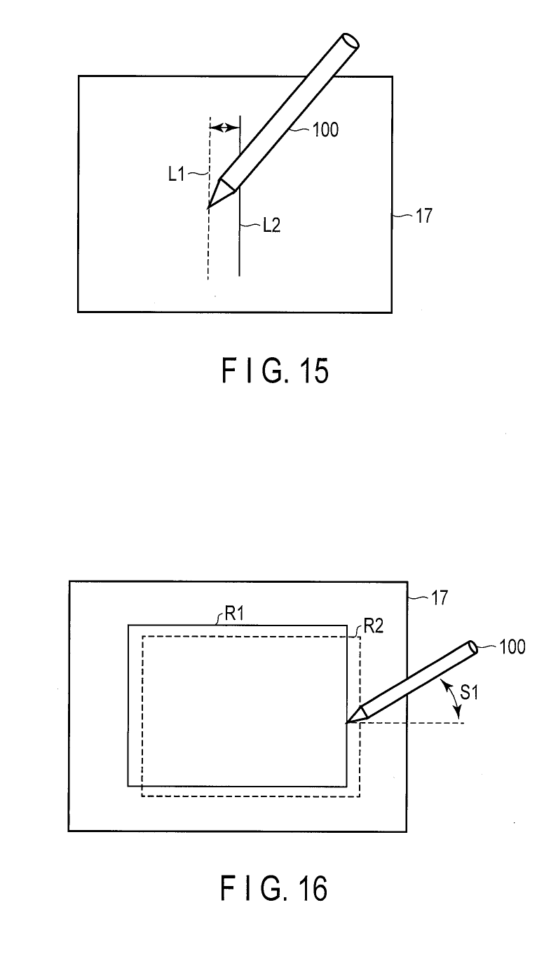

In the second correction data generation process, the second correction data is generated, which is used for correcting a positional gap caused when a normal input operation is conducted by a user. For example, as indicated in FIG. 15, when a user moves the pen point of the pen 100 along line L1 on the touchscreen display 17, line L2 is drawn at a position different from line L1 due to the detection error generated by inclination of the pen 100.

The second correction data is data for correcting difference between line L1 and line L2. Therefore, in the second correction data generation process, a user holds the pen 100 as usual and conducts an input operation so as to trace the line displayed on the screen for calibration.

The second correction data generation module 302 inputs a coordinate data sequence through the data input module 301 (block B3) and calculates difference between the position of the line displayed on the LCD 17A and the input coordinate data sequence; in this manner, the second correction data for error correction for each user is obtained (block B4). In short, the gap (Dxu, Dyu) in FIG. 9 is calculated.

The second correction data generation module 302 records the second correction data, associating it with the user identification information in the nonvolatile memory 106 (block B5).

When the tablet computer 10 is used by a plurality of users, the execution of the aforementioned second correction data generation process by each user enables the tablet computer 10 to record the second correction data corresponding to each user in the nonvolatile memory 106.

Next, this specification explains the specific examples of the line displayed on the screen for calibration in the second correction data generation process.

The second correction data generation module 302 displays a figure (rectangle R1) composed of a plurality of lines on the screen for calibration as shown in, for example, FIG. 16. By making the user trace rectangle R1 with the pen 100, the second correction data generation module 302 calculates the gap amount between the user-expected position of line R2 and the position shown by the coordinate data detected as the contact position of the pen point. The second correction data generation module 302 can correct errors depending on each user in consideration of the angle of eye direction and the inclination of the pen 100 by generating the second correction data based on the gap amount.

Depending on the user, the direction of eyes, the inclination of a pen, and the way of holding the pen 100 differ; however, it is possible to perform positional correction with the natural eye direction and the natural inclination of the pen 100 when the user draws a picture or writes characters, thus, it is possible to correct the position in accordance with the habit of each user at the time of writing something with a pen.

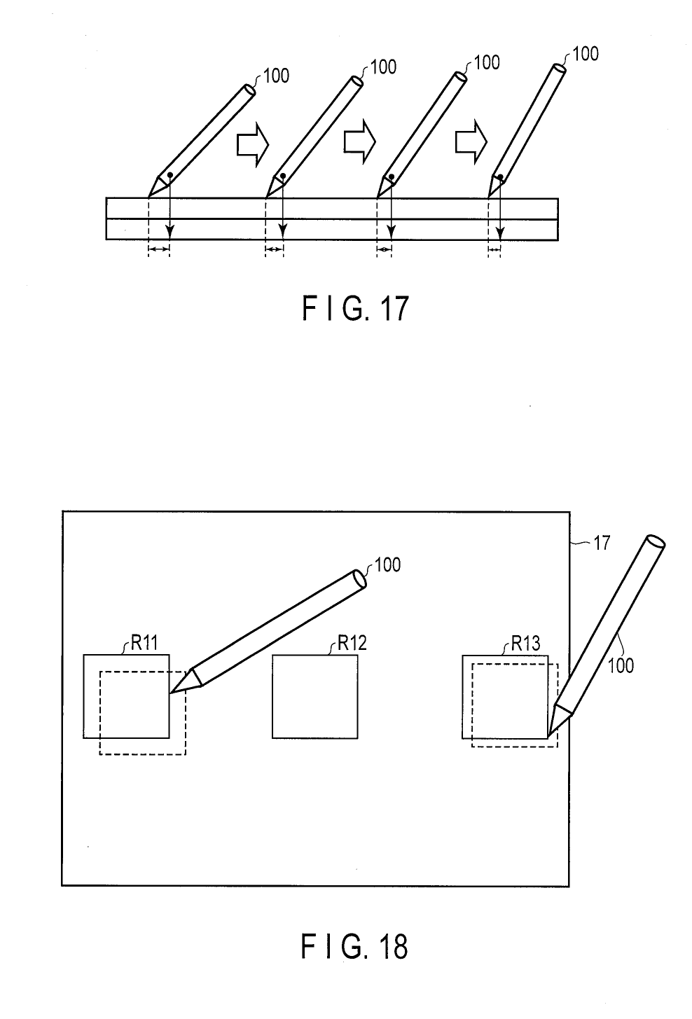

As shown in FIG. 17, there is the following tendency; the more distant from the writing hand the input operation is conducted, the more the pen 100 inclines; the closer to the writing hand the input operation is conducted, the more vertically the pen stands. FIG. 17 indicates a case where the pen 100 is held with a right hand.

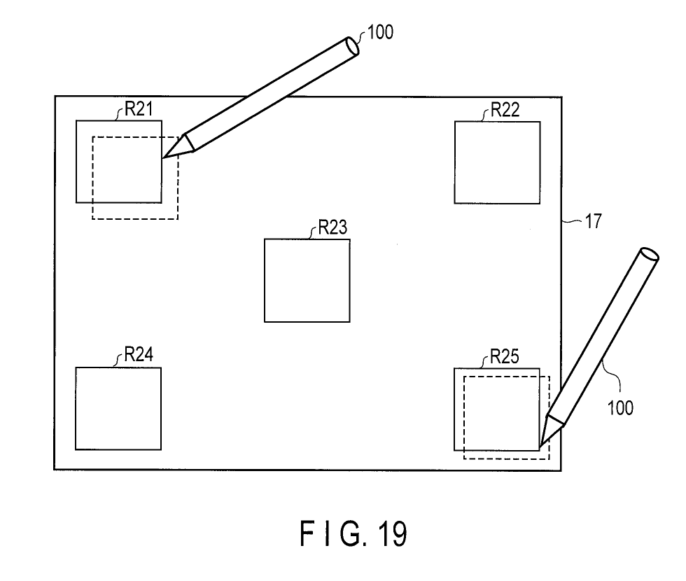

Therefore, as illustrated in FIG. 18 and FIG. 19, a figure for calibration may be displayed in a plurality of places on the touchscreen display 17 to calculate a positional gap in each place and generate a plurality of items of second correction data corresponding to the places respectively. Thus, the positional gap can be more accurately corrected by selecting second correction data corresponding to different positions and applying a correction process in accordance with the region in which an input operation is conducted on the touchscreen display 17.

The inclination of the pen 100 and the angle of eye direction may differ depending on the operation position even if the same user conducts input operations, and even in such a situation, it is possible to perform more accurate positional correction by changing the second correction data in accordance with the position (region) of the input operation by the pen 100.

FIG. 18 shows an example displaying three rectangles R11, R12 and R13 as figures for calibration. Rectangles R11, R12 and R13 are arranged in line in a lateral direction in the center of the screen in a top-and-bottom direction.

FIG. 19 shows an example displaying five rectangles R21, R22, R23, R24 and R25 as figures for calibration. Rectangle R21 is displayed at the upper left corner of the touchscreen display 17. Rectangle R22 is displayed at the upper right corner of the touchscreen display 17. Rectangle R23 is displayed in the center of the touchscreen display 17. Rectangle R24 is displayed at the lower left corner of the touchscreen display 17. Rectangle R25 is displayed at the right lower corner of the touchscreen display 17.

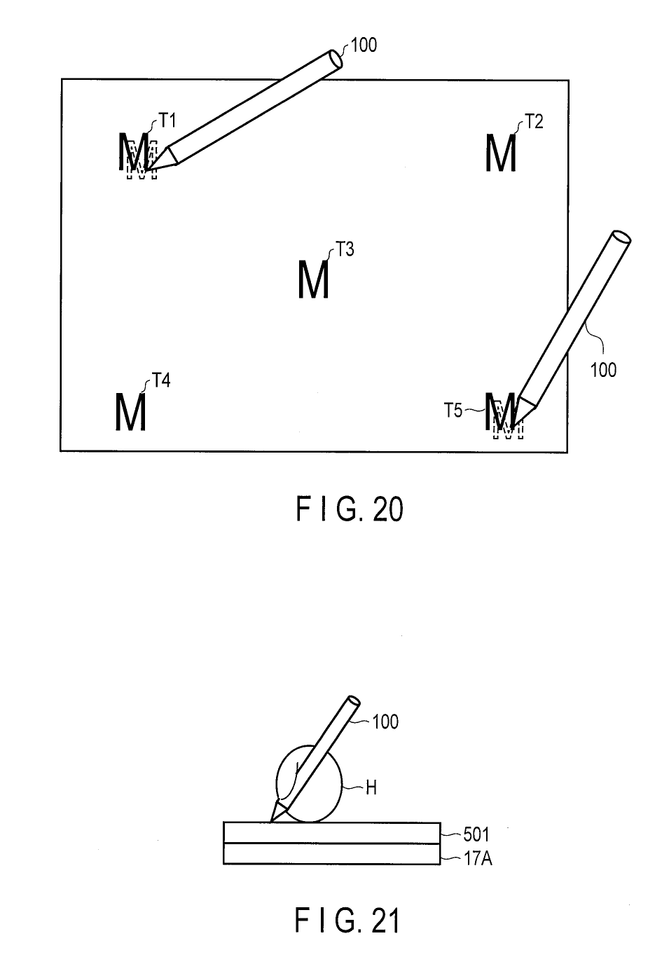

Instead of figures, characters may be used for calibration as shown in FIG. 20. FIG. 20 shows an example displaying five characters T1, T2, T3, T4 and T5 as figures for calibration. Character T1 is displayed at the upper left corner of the touchscreen display 17. Character T2 is displayed at the upper right corner of the touchscreen display 17. Character T3 is displayed in the center of the touchscreen display 17. Character T4 is displayed at the lower left corner of the touchscreen display 17. Character T5 is displayed at the lower right corner of the touchscreen display 17.

When characters are input in handwritten, a user sometimes holds the pen 100 in a different manner from the case of inputting figures in handwriting. Therefore, it is possible to more accurately correct a positional gap by generating second correction data using characters instead of figures and applying a correction process using the second correction data when characters are input in handwriting.

The second correction data generation module 302 can also generate the second correction data by inputting data showing the position of the user's hand detected by the touchpanel 17B, together with the coordinate data detected by the digitizer 17C through the data input module 301.

For example, as shown in FIG. 21, when a hand H holding the pen 100 makes contact with the touchscreen display 17, the second correction data generation module 302 determines whether the user holds the pen 100 with a right hand or a left hand based on the coordinate data showing the contact position of the pen point of the pen 100 as well as the data showing the position of the hand H. Specifically, when the data showing the position of the hand H is on the right side of the coordinate data showing the contact position of the pen point, it is possible to determine that the user conducts the input operation, holding the pen 100 with the right hand. Similarly, when the data showing the position of the hand H is on the left side of the coordinate data showing the contact position of the pen point, it is possible to determine that the user conducts the input operation, holding the pen 100 with the left hand. The second correction data generation module 302 adds data for right hand input or left hand input to the second positional data calculated based on the input coordinate data, and records the data in the nonvolatile memory 106. In a correction process, when it is possible to determine whether the user holds the pen 100 with the right hand or the left hand, an error can be more accurately corrected by selecting the second correction data in accordance with the right hand or the left hand and conducting the correction process.

Next, this specification explains a method for inputting coordinate data used for calculating second correction data in accordance with input operations relative to figures for calibration.

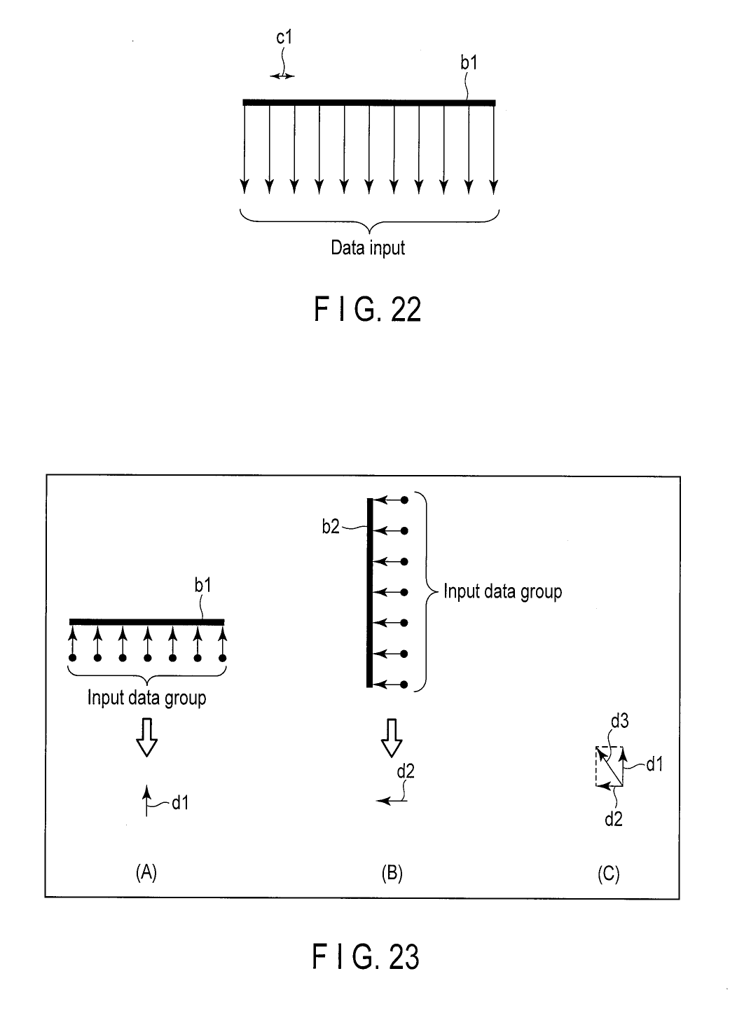

For example, touch operations by the digitizer 17C are detected in cycles of 100 Hz. In this case, for example, as shown in FIG. 22, when a segment (b1) is written by the operation of the pen 100, a detection signal is output 100 times per second, in other words, a detection signal is output per 10 ms (c1). Thus, the data input module 301 is configured to correct many detection signals from one-time writing by a user.

A plurality of detection signals input by the data input module 301 are supplied to the second correction data generation module 302. The second correction data generation module 302 selects a detection signal that should be used for calibration among a plurality of detection signals supplied from the handwriting data input module 301.

The second correction data generation module 302 extracts a component relating to a gap between a position of a calibration figure displayed on the touchscreen display 17 (LCD 17A) and a position detected by the digitizer 17C by an input operation tracing the figure.

Coordinate data is included in the detection signal output from the digitizer 17C. According to coordinate data, it is possible to know at which position on the touchscreen display 17 a touch operation corresponding to the detection signal is performed. However, when a user writes a segment on the touchscreen display 17, tracing a segment shown in the figure displayed on the touchscreen display 17 and thus a detection signal is obtained, (differently from the touch operation relative to, for example, a point-like object,) it is impossible to know when the touch operation position shown by the coordinate data included in the detection signal is obtained, specifically, it is unknown where on the segment shown in the figure is traced by the user when the touch operation position shown by the coordinate data included in the detection signal is obtained.

The second correction data generation module 302 presumes that the position of the touch operation corresponds to the position which is on the written segment and whose direction relative to the segment composed of the detection positions of the touch operations is orthogonal to the segment shown by the figure.

Thus, the second correction data generation module 302 presumes the positions on the corresponding segment relative to the positions of the touch operations respectively, and then the second correction data generation module 302 calculates each distance between the corresponding positions, and calculates an average value. By this process, as shown in FIG. 23, the second correction data generation module 302 is configured to calculate a vertical gap component (d1) based on a plurality of detection signals by writing a horizontal line on the touchscreen display 17 (FIG. 23(A)), and to calculate a horizontal gap component (d2) based on a plurality of detection signals by wiring a vertical line on the touchscreen display 17 (FIG. 23(B)). From these vertical and horizontal gap components, it is possible to obtain a correction value (d3) for conforming the display position of the touchscreen display 17 (LCD 17A) to the detection position by the touchscreen display 17 (digitizer 17C).

The second correction data generation module 302 calculates a correction value based on the extracted gap components, and sets this correction value as the second correction data for conforming the display position of the touchscreen display 17 (LCD 17A) to the detection position by the touchscreen display 17 (the touchpanel 17B or the digitizer 17C).

As mentioned above, the contact position of the pen 100 with the touchscreen display 17 is detected by the digitizer 17C which is an electromagnetic induction type of pointing device. Even if the contact position detected by the digitizer 17C is the same position on the touchscreen display 17, the contact position may differ depending on the contact angle of the pen 100 relative to the touchscreen display 17. Therefore, the length of the segment shown in the figure displayed by the second correction data generation module 302 is set in such a way that the angle of the pen 100 is not dramatically changed (the angle does not exceed a threshold) while the segment is written.

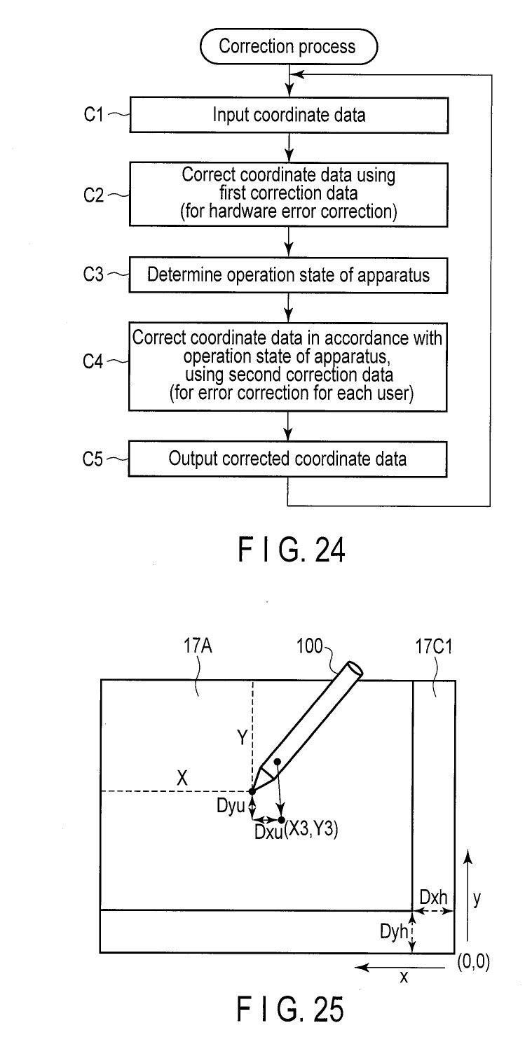

Next, this specification explains a correction process using the first correction data and the second correction data with reference to a flowchart shown in FIG. 24.

The calibration utility program 204 is set to be resident and operate when an input operation is conducted by the pen 100. If a user of the tablet computer 10 is identified by a password input, etc., when the tablet computer 10 is activated, the calibration utility program 204 searches the nonvolatile memory 106 for the second correction data 106B corresponding to the user of the tablet computer 10 based on user identification information, and loads the second correction data 106B as well as the first correction data 106A into the main memory 103.

If coordinate data is input through the data input module 301 (block C1), the correction module 304 corrects coordinate data by the use of the first correction data 205 (block C2). Thus, an error caused by hardware is corrected by the first-stage correction.

Next, the second correction module 306 corrects the coordinate data corrected by the first correction module 305 by the use of the second correction data 206. Thus, an error caused by the way used by a user is corrected by the second-stage correction. In this manner, it is possible to output correction data corrected in consideration of both of the error caused by hardware and the error caused by the way used by a user to an application or the OS 201 (block C5).

The second correction module 306 can switch the second-stage correction process in accordance with the operation state determined by the determination module 307.

For example, when the tablet computer 10 is rotated, the determination module 307 determines the orientation of the touchscreen display 17 by the notification from the OS 201, and causes the second correction module 306 to execute a correction process in accordance with the orientation of the tablet computer 10.

For example, when the tablet computer 10 is used in the state shown in FIG. 9, as discussed above, coordinate data is corrected by the calculations shown in the following equations (1) and (2):

X=X1−Dxh−Dxu (1)

Y=Y1−Dyh−Dyu (2)

When the tablet computer 10 is used in the state shown in FIG. 10 (the tablet computer 10 is rotated 90 degrees in the left direction), as described above, coordinate data is corrected by the calculations shown in the following equations (3) and (4):

X=X2−Dxh+Dyu (3)

Y=Y2−Dyh−Dxu (4)

When the tablet computer 10 is used in the state shown in FIG. 25 (the tablet computer 10 is rotated 180 degrees in the left direction), coordinate data is corrected by the calculations shown in the following equations (5) and (6):

X=X3−Dxh+Dxu (5)

Y=Y3−Dyh+Dyu (6)

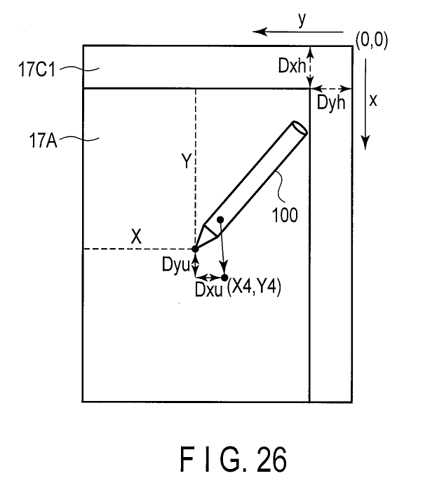

When the tablet computer 10 is used in the state shown in FIG. 26 (the tablet computer 10 is rotated 270 degrees in the left direction), coordinate data is corrected by the calculations shown in the following equations (7) and (8):

X=X4−Dxh−Dyu (7)

Y=Y4−Dyh+Dxu (8)

Thus, as the error caused by hardware is corrected by the first-stage correction process, coordinate data can be corrected by one item of second correction data 206 by changing the calculation method in accordance with the orientation of the tablet computer 10. In short, it is unnecessary to generate the second correction data corresponding to each orientation of the tablet computer 10 in advance.

When the second correction data 206 corresponding to each of application programs 202 and 203 is generated, the second correction module 306 selects second correction data corresponding to the active application determined by the determination module 307, and corrects coordinate data.

When the changeover of the functions (for example, the type of a line) of application programs 202 and 203 is detected by the determination module 307 from the notification from the applications, the second correction module 306 selects the second correction data in accordance with the functions of the applications, and corrects coordinate data.

When the hand H of the user is detected by the touchpanel 17B, the second correction module 306 can also correct coordinate data by determining whether the user holds the pen 100 with the right hand or the left hand based on the positional relationship between the position showed by the coordinate data detected by the digitizer 17C and the position of the hand H, and selecting the second correction data corresponding to the right hand or the left hand.

Moreover, in the examples of the above explanation, the tablet computer 10 is rotated at each angle of 90 degrees; however, for example, a user may conduct an input operation by the use of the pen 100, holding the tablet computer 10. In this case, a posture detection sensor (gyro) is provided in each of the tablet computer 10 and the pen 100, and the tablet computer 10 receives data showing the posture state detected by the posture detection sensor of the pen 100, and calculates a relative positional relationship between the tablet computer 10 and the pen 100 based on the data. In other words, the tablet computer 10 calculates from which direction and at which inclination angle the pen 100 is brought into contact with the touchscreen display 17. The second correction module 306 dynamically determines the second correction data in accordance with the relative positional relationship between the tablet computer 10 and the pen 100, and corrects coordinate data. In the tablet computer 10 of the embodiment, an error caused by hardware is corrected by the first-stage correction process; therefore, it is possible to dynamically correct coordinate data in accordance with the change in the state of the tablet computer 10.

As described above, the tablet computer 10 of the embodiment can conduct a calibration process by dividing it into two stages; in one stage, the tablet computer 10 corrects positional gaps (errors) which are generated in the specific direction in a fixed manner due to hardware mounting; in the other stage, the tablet computer 10 corrects positional gaps which are generated in different directions depending on the state (rotation) of the tablet terminal due to the way used by the user.

Since the correction of the positional gap caused by hardware is separated from the correction of the positional gap caused by the way used by a user, even if a plurality of users use one tablet computer 10, it is possible to conduct positional correction suitable for the preference of each user by completing the correction of the positional gap due to hardware as common correction (correction using the first correction data) in the tablet computer 10 in advance, and performing a calibration process for each user.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The processes described in the aforementioned embodiments can be written, as programs which can be executed by a computer, in a recording medium such as a magnetic disk (a flexible disk, a hard disk, etc.), an optical disk (a CD-ROM, a DVD, etc.) and a semiconductor memory to be offered to various devices. Moreover, it is possible to provide various devices with the processes through the transmission by a communication medium. A computer reads the programs recorded in a recording medium, or receives the programs via a communication medium. The programs control operations, and thus, the above processes are executed in the computer.

What is claimed is:

1. An electronic apparatus comprising:
a display configured to detect a contact position with a first object on the display;
a storage configured to store first data relating to a difference, caused by at least a manufacture of a hardware of the electronic apparatus, between a first position at which the first object makes contact with the display and a second position drawn by the display in accordance with first positional information obtained in accordance with the contact of the first object with the display at the first position;
a generator configured to generate second data relating to a difference in a contact state of a second object with the display, the second data used for determining a fourth position drawn by the display in accordance with second positional information obtained in accordance with contact of the second objet with the display at a third position; and
a processor configured to correct a contact position detected by the display, using the first data and the second data.

2. The apparatus of claim 1, further comprising a first discriminator configured to discriminate an orientation of the display, wherein:
the generator is configured to generate the second data corresponding to a plurality of orientations of the display; and
the processor is configured to use the second data corresponding to one of the plurality of orientations of the display.

3. The apparatus of claim 1, further comprising a second discriminator configured to discriminate an operation state of the electronic apparatus, wherein:
the generator is configured to generate the second data corresponding to a plurality of operation states of the apparatus; and
the processor is configured to use the second data corresponding to one of the plurality of the operation states.

4. The apparatus of claim 3, wherein:
the generator is configured to generate the second data in accordance with a first user and a second user who use the apparatus; and
the second discriminator is configured to discriminate whether a user using the apparatus is the first user or the second user as the operation state.

5. The apparatus of claim 3, wherein:
the generator is configured to generate the second data in accordance with a first application and a second application which are executed in the apparatus; and
the second discriminator is configured to discriminate whether an application executed in the apparatus is the first application or the second application as the operation state.

6. A method of correcting a contact position for an electronic apparatus comprising a display configured to detect the contact position with a first object on the display, the method comprising:
storing first data relating to a difference, caused by at least a manufacture of a hardware of the electronic apparatus, between a first position at which the first object makes contact with the display and a second position drawn by the display in accordance with first positional information obtained in accordance with the contact of the first object with the display at the first position;
generating second data relating to a difference in a contact state of a second object with the display, the second data used for determining a fourth position drawn by the display in accordance with second positional information obtained in accordance with contact of the second object with the display at a third position; and
correcting a contact position detected by the display, using the first data and the second data.

7. The method of claim 6, further comprising discriminating an orientation of the display, wherein:
the generating comprises generating the second data corresponding to a plurality of orientations of the display; and
the correcting comprises correcting the contact position using the second data corresponding to one of the plurality of orientations of the display.

8. The method of claim 6, further comprising discriminating an operation state of the apparatus, wherein:
the generating comprises generating the second data corresponding to a plurality of operation states of the apparatus; and
the correcting comprises correcting the contact position using the second data corresponding to one of the plurality of operation states.

9. The method of claim 8, further comprising generating the second data in accordance with a first user and a second user who use the apparatus, wherein:
the discriminating comprises discriminating whether a user using the apparatus is the first user or the second user as the operation state.

10. The method of claim 8, wherein:
the generating comprises generating the second data in accordance with a first application and a second application which are executed in the apparatus; and
the discriminating comprises discriminating whether an application executed in the apparatus is the first application or the second application as the operation state.

11. A computer-readable, non-transitory storage medium having stored thereon a computer program which is executable by a computer comprising a display configured to detect a contact position with a first object on the display, the computer program controlling the computer to function as:
a storage configured to store first data relating to a difference, caused by at least a manufacture of a hardware of the electronic apparatus, between a first position at which the first object makes contact with the display and a second position drawn by the display in accordance with first positional information obtained in accordance with the contact of the first object with the display at the first position;
a generator configured to generate second data relating to a difference in a contact state of a second object with the display, the second data used for determining a fourth position drawn by the display in accordance with second positional information obtained in accordance with contact of the second objet with the display at a third position; and
a processor configured to correct a contact position detected by the display, using the first data and the second data.

12. The medium of claim 11, the computer program further controlling the computer to function as a first discriminator configured to discriminate an orientation of the display, wherein:
the generator is configured to generate the second data corresponding to a plurality of orientations of the display; and
the processor is configured to use the second data corresponding to one of the plurality of orientations of the display.

13. The medium of claim 11, the computer program further controlling the computer to function as a second discriminator configured to discriminate an operation state of the computer, wherein:
the generator is configured to generate the second data corresponding to a plurality of operation states of the computer; and
the processor is configured to use the second data corresponding to one of the plurality of operation states.

14. The medium of claim 13, wherein:
the generator is configured to generate the second data in accordance with a first user and a second user who use the computer; and
the second discriminator is configured to discriminate whether a user using the computer is the first user or the second user as the operation state.

15. The medium of claim 13, wherein:
the generator is configured to generate the second data in accordance with a first application and a second application which are executed in the computer; and
the second discriminator is configured to discriminate whether an application executed in the computer is the first application or the second application as the operation state.
